(19) United States
(12) Patent Application Publication
(10) Pub. No.: US 2022/0132216 A1
(43) Pub. Date: Apr. 28, 2022

(54) SYSTEM AND METHOD OF PARALLEL DATA CAPTURE AND TAGGING IN VIDEOS

(71) Applicant: Edekee Inc., West Orange, NJ (US)

(72) Inventors: Paul Onaodowan, Ekpan (NG); Mavino Michael Ikein, Effurun (NG)

(73) Assignee: Edekee Inc., West Orange, NJ (US)

(21) Appl. No.: 17/510,121

(22) Filed: Oct. 25, 2021

Related U.S. Application Data
(60) Provisional application No. 63/105,260, filed on Oct. 24, 2020.

(51) Int. Cl. H04N 21/478; G06N 20/00; H04N 21/8545; H04N 21/81; H04N 21/858

(52) U.S. Cl. CPC H04N 21/47815; G06N 20/00; H04N 21/858; H04N 21/8133; H04N 21/8545

(57) ABSTRACT

A system and method for parallel data capture in video comprising a retailer module having memory adapted and configured to accept product images, product information, and product identifying information related to one or more products, a tagging module having memory and storage adapted and configured to generate unique identifying tags associated with each of said one or more products, a database module having storage for storing product images, product information , product identifying information and tags and an identification module having memory adapted and configured to receive video content and identify said one or more products contained with said video content. The modules are configured, such that said unique identifying tags are associated with video content associated with said one or more products contained within said video content to generate concatenated video content and said concatenated video content is delivered to a consumer.

### RELATED APPLICATIONS

The present application claims the benefit of priority under 35 U.S.C. 119 to prior-filed and co-pending U.S. Provisional Patent Application Ser. No. 63/105,260, filed on Oct. 24, 2020 by Paul Onaodowan, the complete content of which is hereby incorporated herein by reference.

### BACKGROUND

### Technical Field

The present device relates to the field of location, identification and tagging systems and methods and more particularly the use of Artificial Intelligence (AI) and/or Machine Learning(ML) to identify, tag and provide secure purchase options to users directly from video or still images, in a digital or virtual environment.

### BACKGROUND

Consumers desire the ability to identify various products and services accurately and have greater access to them. However, a problem exists for consumers wherein this is a lack of product and service visibility and access. This problem exists whether the product or service is observed by the consumer on the ground on it is observed by the consumer on TV or on the internet, the invention helps the consumer to identify them and purchase them if he so wishes. A further problem and a common experience for many e-commerce shoppers is observing a beautiful product online and getting an imitation of that product when ordered. What is needed is a system and method that allows a consumer to purchase the product that the consumer has seen on the ground and to avoid ambiguities. A system and method by which a buyer can confirm the authenticity of the brand on the spot is also desirable.

For seller, a common problem is product visibility and informing consumers where a product may be available for purchase.

As the e-commerce market continues to evolve, more and more demand is placed on brand and product identification. Consumers (for the sake of shopping) and Retailers (for the sake of inventory) often need to identify accurately and quickly too, the various brands and products before them. Consumers typically turn to Image Recognition (IR) methods to help them during this brand identification process. Unfortunately, at the time of this invention, IR techniques are unreliable for item/product/brand identification.

Currently, viewers of video content find it difficult to access or obtain details regarding retail commodities such as price, name, location and other description of the products and services found in video or still frame images. Even though video streaming is currently ubiquitous, this basic information regarding products depicted within video and still images is not readily available to consumers on the individual frames of a video for quick and easy user interaction. Current methods available for a consumer to obtain such information (if available) include listing of objects of interest or commodities available for sale on an image viewer, separate from the image or video itself, or tagging the commodities on images only.

Another known system is a graphical user interface (GUI) in the areas surrounding the video frame, as described in U.S. Patent Publication 2014/0282743. However, the described system and method does not provide a seamless user experience in this fast-paced video streaming world, thus limiting the buying options for consumers to social-media commerce and commercial sites. This problem exists whether the video content is streamed or viewed offline via viewing devices.

Solutions to problems associated with identifying and tracking the location of objects in videos have been commonly explored in the past. Such objects include facial recognition for security purposes, video analysis and tracking of such a user/user's face. In such solutions, human faces and/or other objects are tracked across a sequence of frames in real-time, while generating the relevant GUI to represent those detected objects across the frames. Tracking of the identifying tag overlay is made determined and presented using frame-by-frame tracking of movement or change in the position of tracked element and repositioning of the GUI tagging element by a tagging module in each frame. In some embodiments, static objects can also identified using the above method and, in some embodiments, viewers can be given control over the display of video tagging overlays of moving and stationary objects while viewing the videos.

In other video presentation methods described in U.S. Pat. No. 8,362,821, a user request is used to obtain from a URL, the video content and an overlay content are then merged to form a playlist in a browser. The video can then be played by the user and GUI tags are placed on desired objects across a sequence of frames in real-time as the video is played. In such embodiments, the GUI can respond to end-user clicks, by linking to content associated with the tagged object.

For consumers viewing video content on the internet and especially on social media, advertising, interrupting viewing, can be annoying. Additionally, in some cases user sensitive data can be obtained nefariously from or about consumers which could be abused by displaying repeated identical or similar advertising to the user while the content is being viewed, with the sole purpose of convincing the user/consumer to buy certain products or services. Given the existing methods for exploring video content, solutions are not tailored to directly shop for products and services from within videos. Again, U.S. Patent Publication 2014/0282743 proposes only an ancillary list of selectable images with content which may be related to those in the video presented.

What is needed in today's fast-streaming videos and social media video content is AI assisted clickable tag overlays for retail commodities which can be distributed across the frames of such videos. Commerce for video content also requires reliable payment gateways such as is presented by Blockchain or other Decentralized Ledger Technologies (DLT) or more commonly, traditional card or mobile payment solutions like NFC.

Moreover what is needed is streamlined solutions as proposed herein which are useful for video social commerce and video commerce in general. Currently, product visibility in videos is also a problem for sellers; particularly in digitally native brands or direct-to-consumer type businesses and for content creators, because in current social media space, strategically placed and clickable products and services in video content is largely unavailable. This lack of ability to shop directly from video problem creates a situation in which consumers are largely unable to easily and directly interact with the retail commodities directly via the video content.

What is needed is a system and method that places control of the shopping experience in the hands of the consumers, thus giving the consumer the ability to choose when or whether to view content that they find interesting in a video and shop from within the content. What is needed is a system and method that can generate a user request to a remote server to determine or gain further clarification/information about a product or service of interest while viewing the video content. Moreover, what is needed is a system and method to ease consumer identification of retail commodities in videos rather than real-time frame-by-frame object tracking across videos with constant display of overlays, as described by known/older systems. What is needed is a system and method wherein a user can directly interact with a video and directly obtain information regarding products of interest contained/depicted within the video.

Current systems also do not permit content creators or retailers the ability to accurately identify their products within video such that viewers can easily select products within a video and thereby obtain additional information regarding the product and/or be directed to sources to purchase the identified item(s). What is needed is a system or method which enables retailers and video content creators to easily include product placement within video content. What is needed is a system and method that enables retailers and content creators to provide information about their products and services prior to video production wherein machine learning employs image classification or object recognition techniques to build useful data for video playback by consumers.

What is needed is a system and method of simultaneous capture of EPC/GS1 tag code data, the respective tag locations, and the digital image of the area/object where the tags are physically located, automatically. Additionally, a EPC/GS1 tag code and tag relative position, can be subsequently projected on a digital image captured by a digital camera on the system. This can be useful wherein UHF RFID reader, tag relative positioner, and Digital camera, all exist in one system for creating an embedded image or video.

### BRIEF DESCRIPTION OF THE DRAWINGS

Further details of the present device are explained with the help of the attached drawings in which:

FIG. 1 depicts a system of parallel data capture of one or more items.

FIG. 2 depicts a flow diagram of a method of parallel data capture of one or more items.

FIG. 3 depicts a system of parallel data capture of one or more items in video.

FIG. 4 depicts a flow diagram of a method of parallel data capture of one or more items in video.

FIG. 5 depicts a computer system adapted and configured to implement the system and methods described herein.

FIG. 6 depicts a system and method of parallel data capture of one or more items with item tagging and identification.

FIG. 7 depicts a system and method employed in association with the system and method of FIG. 6, which can be associated with a consumer interaction.

FIG. 8 depicts a system and method employed in association with the system and method of FIG. 6, which can be associated with a retailer interaction.

FIG. 9 depicts a system and method employed in association with the system and method of FIG. 6, which can be associated with a content creator interaction.

FIG. 10 and exemplary embodiment of a tagged image employing the systems and methods of FIGS. 6-9

FIG. 11 depicts a system and method employed in association with the system and method of FIG. 6, which can be associated with a retailer interaction.

FIG. 12 depicts a system and method employed in association with the system and method of FIG. 6 related to processing of video/images.

FIG. 13 depicts a system and method employed in association with the system and method of FIG. 6, which can be associated with a consumer interaction.

FIG. 14 depicts a system and method employed in association with the system and method of FIG. 6, which can be associated with a consumer interaction.

FIG. 15 an exemplary embodiment of the tagging and item identification/verification systems and methods of FIGS. 6-9 and 11-14.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect can comprise a retailer module having memory adapted and configured to accept product images, wherein the retailer module also comprises a tagging module having memory and storage adapted and configured to generate unique identifying tags associated with each of said one or more products; a database module having storage for storing product images, product information, product identifying information and tags; and an identification module having memory adapted and configured to receive video content and identify said one or more products contained with said video content; wherein said unique identifying tags can be associated with video content associated with said one or more products contained within said video content to generate concatenated video content; and wherein said concatenated video content can be delivered to a consumer. Other embodiments of this aspect include corresponding computer systems, apparatus, and computer programs recorded on one or more computer storage devices, each configured to perform the actions of the methods.

Implementations can comprise one or more of the following features: a consumer module adapted and configured to enable consumer viewing and interaction with said concatenated video content; consumer interaction with said concatenated video content can result in delivery of information regarding said one or more products contained within said video content; a commercial transaction module adapted and configured to enable a commercial transaction between a consumer and a retailer related, at least in part, to said one or more products contained within said video; a commercial transaction module adapted and configured to enable a commercial transaction between a consumer and a retailer related, at least in part, to said one or more products contained within said video. Said one or more products can be identified within said video content. The system can comprise: a consumer module adapted and configured to enable consumer viewing and interaction with said concatenated video; a commercial transaction module adapted and configured to enable a commercial transaction between a consumer and a retailer related, at least in part, to said one or more products contained within said video. Said one or more products contained within said video content are identified, at least in part, by one or more properties of said one or more products. Said one or more products contained within said video content are identified, at least in part, by one or more properties of said one or more products. One of said one or more physical properties is at least one geometric property of said one or more products. The system can comprise: a consumer module adapted and configured to enable consumer viewing and interaction with said concatenated video. a commercial transaction module adapted and configured to enable a commercial transaction between a consumer and a retailer related, at least in part, to said one or more products contained within said video. One of said one or more physical properties is the presence of a logo on said one or more products; a consumer module adapted and configured to enable consumer viewing and interaction with said concatenated video; a commercial transaction module adapted and configured to enable a commercial transaction between a consumer and a retailer related, at least in part, to said one or more products contained within said video. One of said one or more physical properties is the presence of a logo on said one or more products. Implementations of the described techniques may include hardware, a method or process, or computer software on a computer-accessible medium.

### DETAILED DESCRIPTION

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

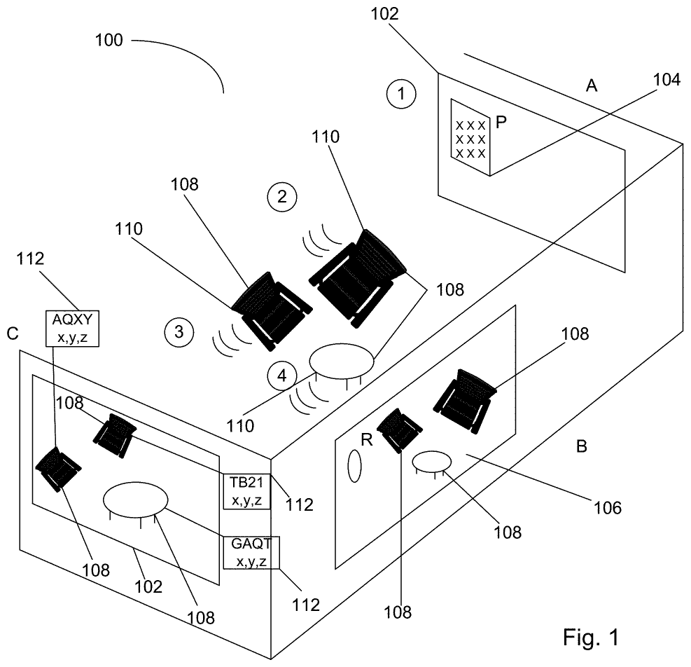

FIG. 1 depicts a system 100 of parallel data capture of one or more items In the embodiment depicted in FIG. 1, the system 100 comprises a mobile computing device 102 having a plurality of data capture inputs 104 and a display 106. Further, the system comprises RFID tags 108 associated with one or more items 110. In operation, items 110 can be associated with RFID tags 108 and a mobile computing device 102 can be used to capture an image of item(s) 110, the associated RFID tag 108 information and a relative position 112 of the item 110/RFID tag 108 within the image. In operation, the mobile comping device 102 can comprise a plurality of sensors adapted and configured to capture the relevant information.

The described system and method is a design of a system of simultaneous or near-simultaneous capture of EPC/GS1 tag code data, the respective tag locations, and the digital image of the area/object where the tags are physically located, all with the same command. Both EPC/GS1 tag code and tag relative position can subsequently be projected on the digital image which was captured by a digital camera on the system. UHF RFID reader, tag relative positioner, and Digital camera, all existing in a system.

Data code to be captured by this method and system can be displayed in QR/Bar code form, binary form, or hexadecimal form, or as URL link, or in digital image form, or any combination of these forms. The UHF RFID tag code data can be displayed visibly or steganographically on the digital Image/video of the tag physical surrounding.

Images/videos can be created, can be viewed on the digital screens of Smartphones, Tablets, Television, and Personal computers, or can be viewed on 2D surfaces or projected on holographic surfaces. The hardware components for this combined system can either be integrated with the electronic circuit of a Smartphone, Tablet, Video camera or another mobile device or connected externally as a separate hardware through USB, wireless, UART or other connection with to the aforementioned. In some embodiments, the system can comprise a phased array antenna or any other UHF RFID antenna type for seamless TX/RX of Radio frequency (RF) signals to and from UHF RFID tags in the environment and also project relative coordinates of the same tags on the digital image.

For better item recognition methods, UHF RFID technology can be employed. Although, already common with retail inventory management, UHF RFID is largely unexplored in consumer electronics (particularly Smartphones, Tablets, Television and digital cameras) due to unfounded public misinformation about, and suspicion for, the technology. Unlimited opportunities for ecommerce retailers and consumers, lie in the system and method described herein when considered for digital screen display. In some embodiments, consumer goods and services goods can also be accessed directly through the digital screens of Television, Personal computers and Smartphones with/without the aid of the internet when those products are embedded with UHF RFID tags. Also, in some embodiments, is the possibility of advertising on digital screens.

Electronic product code (EPC) and GS1 specifications for embedded UHF RFID tags on; products (SGTIN), leisure industry and other service providers (GSRNP), enables opportunities in advertising of various products and brands especially when the system and method is utilized in 3D models, 3D virtualization, as well as holographic projections. In some embodiments and uses, the disclosed system and method can open up brand visibility in ecommerce or social commerce to consumers and retailers alike, through digital screens, and improve inventory management methods for businesses as well. The foregoing detailed description described and depicts a system and method of capturing the EPC/GS1 code data of UHF RFID tags, comprising their relative positions to the capturing device, and the ability to display the result externally on a digital screen.

In some embodiments, the system and method describes capturing UHF RFID tag data via the digital screens of smartphones and the digital screens of other mobile devices whilst also displaying the relative location of each detected tag on the digital image/video (of the environment) where the tags physically exist is enabled. That is, in some embodiments, tag data, and tag location relative to capture device, can be displayed (visibly or steganographically) or other encrypted formats such as QR code, URL, product/service ID, or other format on the digital image/video of the environment where the tags physically exist.

In some embodiments, the system and method can aid the human sensory processing action in selecting the tag of choice, by displaying the relative positions of the UHF RFID tags on the picture of the area where they physically exist, at a given time. Hence the tripartite action of UHF RFID data capture, tag relative positioning, and image capture of tag environment by digital camera occur simultaneously or substantially simultaneously. Subsequently, the system can display the result from the first two actions on the third. All three actions can be initiated by a single command. The user of the resulting digital image/video can then access the data on those tags, via linking to a remote server. This coordinated action can be advantageous in situations where numerous tags exist in an initial environment, and the user wishes to identify the tags individually at a particular instance of time. In some embodiments, the system and method can project the information of the tag, on the digital image of the area where the tags were captured. That image of the area where the tags were captured can be displayed on a digital screen (like TV, PC, or smartphone), or it could be displayed on a printed surface or displayed on a hologram. Once available on the digital screen of a user, if it is interactive (the tag data could be provided as a URL or product/service ID link or a fancy icon representing the link) which can then be clicked by the user. By clicking this link, the user can be taken to the site of a remote server from which information about the UHF RFID tag can then be accessed by the user. However, on the occasion where the digital screen where tag data code and relative position is presented is not smart, the user can then use an image recognition (IR) application on a second digital screen that can be smart (touch screen) to decipher the tag URL, QR bar code or whatever is provided and link up with the tag information on a remote server where the user can purchase the item/product in which the tag is contained. Where one or more UHF RFID reader mobile devices exist in the presence of one or more UHF RFID tags within the same area at the same time and time range, any of such devices when activated to interrogate the tag/tags within its environment, can first set up a WLAN. This WLAN can precede any UHF RFID action from any mobile device within this network. The WLAN can then create an air interface protocol for several mobile devices whose users engage with the system and/or method, in identifying items of interest within that environment.

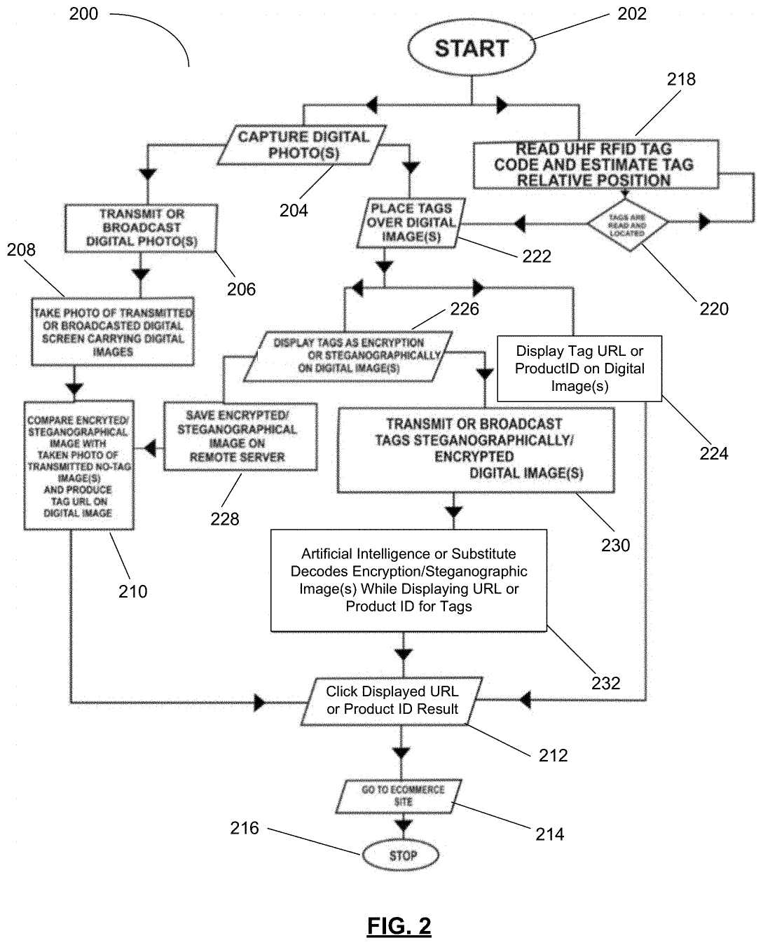

FIG. 2 depicts a flow diagram 200 of a method of parallel data capture of one or more items. In step 202, the process is commenced. In some embodiments the process can be commenced automatically and periodically. However, in alternate embodiments, the process can be manually initiated.

In step 204, an image of items 110 can be captured and stored or instantiated in memory or recorded in any other known, convenient and/or desired manner. Then in step 206 the image can be transmitted or broadcast, and in step 208 an secondary image of the transmitted or broadcasted image can be captured and stored or instantiated in memory or recorded in any other known, convenient and/or desired manner.

Then in step 208, the secondary image can be compared with stored data from step 228 (described more fully infra) to generate a tag URL or product/service ID on digital image, such that the tag link can be accessed and displayed in step 212 and an associated ecommerce/social commerce site can be accessed and displayed in step 214, before the process stops in step 216.

In parallel with step 204, the method 200 can capture an RFID tag code and relative position associated with an item in step 218 and if multiple RFID tag codes and items are detected then in step 220, the process of step 218 can be repeated for each detected RFID tag codes.

Then in step 222, the RFID tag codes and associated relative positions are combined with the image captured in step 204.

In some embodiments, the combined image, RFID tag information and relative position information can then be combined with a URL in step 224 before proceeding to steps 212 through 216.

In some embodiments, the combined image, RFID tag information and relative position information can be the RFID tag and/or relative position information can be encrypted within the image in step 226, either in a visually perceptible manner such as a QR code or in a generally imperceptible manner, such as steganographically within the image. The encrypted image can then be used as a comparative image in step 210. The encrypted image can also be transmitted or broadcast in step 230 before the process proceeds to step 212-216.

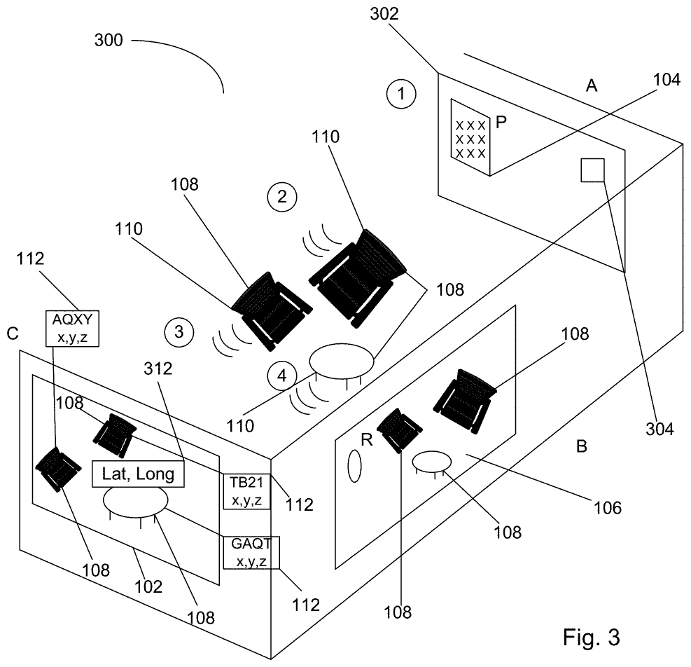

FIG. 3 depicts a system 300, similar to system 100, of parallel data capture of one or more items in video incorporating GPS. In the embodiment depicted in FIG. 3, the system 300 comprises a video and data capture device 302 having a plurality of data capture inputs 104, a GPS system 304 and a display 106. Further, the system comprises RFID tags 108 associated with one or more items 110. In operation, items 110 can be associated with RFID tags 108 and a data capture device 302 can be used to capture video frame images of item(s) 110, the associated RFID tag 108 information and a relative position 112 of the item 110/RFID tag 108 within a video frame and an associated GPS position 312. In operation, the data capture device 302 can comprise a plurality of sensors adapted and configured to capture the relevant information.

In some embodiments, the system 302 provides a method of automatically or semi-automatic capturing of UHF RFID code data of various products, (and the relative position of the tags) as well as the GPS geo tag information of visible physical structures in the surrounding area, on the frames of digital videos will filming the video. A network of GPS enabled video cameras (each camera with a combination of antennas) is utilized to achieved this.

In the embodiment depicted in FIG. 3, the system 302 of UHF RFID transceiver antennas as well as GPS receivers, enable a method of automatic or semi-automatic data capturing into video frames during a filming process. In some embodiments, the system 302 can comprise of one or more video cameras all recording the film at a particular scene. However, each video camera can have a set of integrated or externally connected RFID antennas. In the case of automatic capturing, a particular video camera can have a combination of one or more TX/RX antenna systems for detecting passive tags in the 860 MHz-960 MHz range (and/or any other known convenient and/or desired frequency range), and it can further comprise a GPS receiver. The GPS receiver can receive real time aerial mapping of its surrounding environment (to a reasonable mile radius). The system can then trace corner points of physical structures on this aerial map, determine coordinates, crop out unwanted information (based on camera viewing area), provide an internal identification mechanism for each unit of physical structure, search the internet for information about the structures that match with the coordinates and obtain one or more URLs associated with this information. Then one or more URLs/product IDs can be attached to each physical structure in the camera view (and based on the internal identification mechanism) and stored in the video frame and/or in an associated synchronous file. A WLAN can be used to provide a protocol for control of this system of UHF RFID antennas on the various cameras at the scene of the same film shooting project so as to reduce the effect of interference and facilitate the data capture process. A timestamp function can be included in the system to account for coordination between the various camera-antenna-gps systems within the network during filming at a specific scene. The video camera(s) in question can be handheld, mounted on physical structures, or even mounted on a drone or any Unmanned Aerial Vehicle (UAV). In some embodiments, all camera-antenna units can work together in such a configuration that facilitates coordination from a server.

In some alternate embodiments, a semi-automatic option can be implemented in which items and products can be manually tagged with URLs in video frames. Artificial Intelligence by image recognition or Machine learning is then used to track and identify those products/items in other frames of the video, and automatically labeled as the first manually tagged object was done.

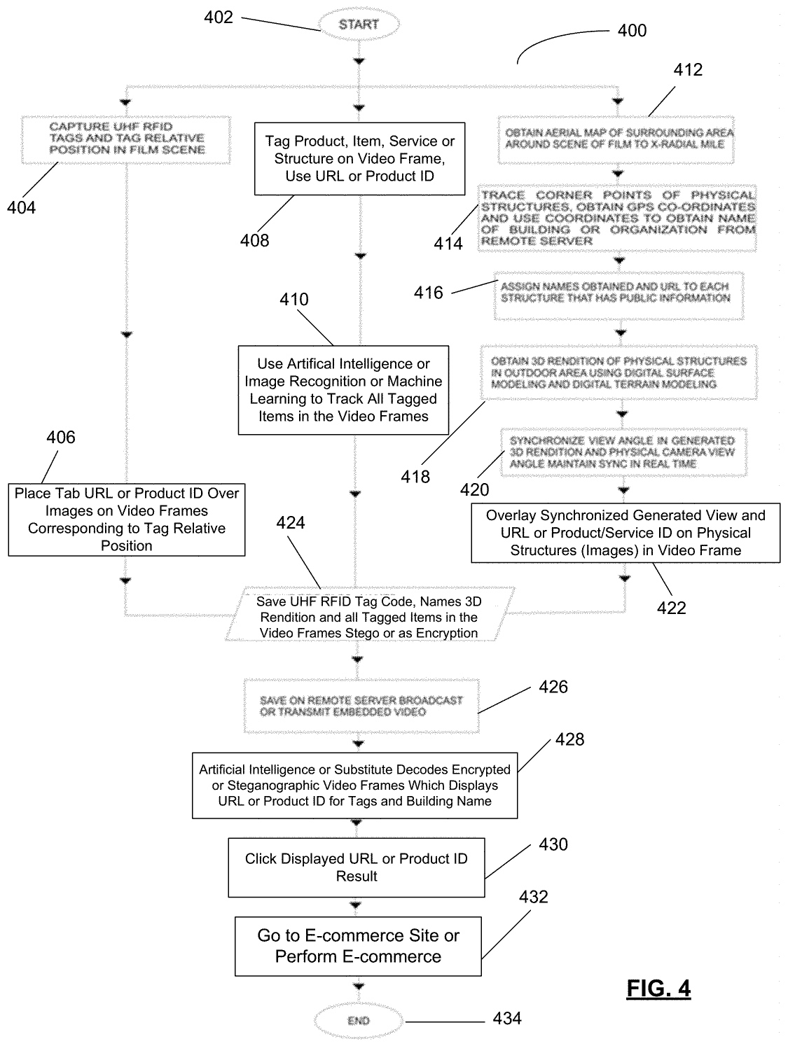

FIG. 4 depicts a flow diagram of a method 400 of parallel data capture of one or more items in video, similar in operation to the system and method described in reference to FIGS. 1 and 2. In step 402 the system is started to process a frame, group of frames or block of video. In step RFID tag data 110 and relative position 112 of items 108 within the frame, frames of block of video are captured. Then in step 406 tag URLs can be coupled with the frame, group of frames and/or block of video containing the item(s). to provide their relative position in within the frame, group of frames and/or block of video.

In a parallel action process, in step 408, items 108 within the frame, group of frames or block of video can be manually tagged and then in step 410 Artificial Intelligence (AI), image recognition, machine learning and/or any other known, convenient and/or desired process can be used to track all tagged items within the frame, group of frames, and/or block of video.

In yet another parallel action process, in step 412 an aerial map can be obtained of the area surrounding the area depicted in the frame, group of frames and/or block of video. Such aerial map can be as detailed and/or granular as desired and can have any known, convenient and/or desired degree of accuracy.

In step 414 structures from the frame, group of frames and/or blocks of video can be processed using techniques such as gaussian edge detection and/or any other known convenient and/or desired image processing technique to determine shapes of surrounding structures. Such shapes of surrounding structures can be used in conjunction with the GPS coordinates captured contemporaneously with the frame, group of frames and/or block of video to determine the identity of the edge detected structures, based on data obtained from any known, convenient and/or desired source. Then in step 416, information regarding identified structures can be determined based on the obtained information.

In step 418, a 3-D rendition of the identified structure(s) can be generated and then in step 420, the 3-D rendering can be synchronized with the associated frame, group of frames and/or block of video. In some embodiments, such rendering and synchronization can occur in real-time or substantially real-time. Then in Step 422, the rendered video can be associated URL data can be synchronized with and merged with the frame, group of frames and/or block of video.

In step 424, the resultant data from step 406, 410 and 422 can be combined with the associated video frame, group of frames and/or block of video. In some embodiments the data can be combined with the frame, group of frames and/or block of video steganographically and/or in any known, convenient and/or desired manner. Then in step 426 the concatenated video/data file can be stored, broadcast or transmitted, as desired.

In step 428, the video frame, group of frames and/or block of video can be decoded and the associated data displayed in association with the video frame, group of frames and/or block of video and in step 430 an identified URL or product ID can be display and/or selected and, if selected, a user can be directed to URL before the process proceeds to step 434 and ends.

In operation the system and method 400 proffers an automated process of UHF RFID data capture and product placement during filming (professional or otherwise). The system and method 400 can take into consideration real life scenarios of using more than one digital video camera for filming videos at a given scene. In some embodiments of the system and method a plurality of UHF RFID antennas be integrated/externally connected to each video camera and used during the filming process.

By way of non-limiting example in some embodiments, a particular video camera can have a set of antennas connected to its internal circuitry such that UHF RFID tag code data is stored in the frames used for recording the film. In each system of antennas for each digital camera, a transmitting and receiving antenna operating between 860 MHZ and 960 MHz (or other known, convenient and/or desired frequency range), can communicate with passive tags in the scene. This particular antenna can aid in capturing code data information and relative position information of the passive tags, within the video frames.

Within the same system 400, a GPS receiver can gather information about visible physical structures in the area and can feed this information into the video recording in the form of URL link. A server can control and/or coordinate the order of UHF RFID data capture between the different antennas serving the different cameras. This server can allocate channels for RF signaling between the various antennas operating in a given frequency spectrum. Additionally, in some embodiments, a timestamp function can also be generated from such a server to facilitate proper editing of the final embedded video.

In some embodiments of the system 400, up to three antennas (on the same recording video camera or across different video cameras) can be used to determine the relative position of UHF RFID tags with respect to this system. Subsequently, the recorded and edited video can be broadcasted, transmitted, streamed or saved in a storage device. Viewers can then access both the UHF RFID code information, and the GPS geo tag information of visible surrounding structures, that are saved in this video once available on the digital screen of a user, if it is a touch screen (the tag data would be provided as a URL link or a fancy icon representing the link) which can then be clicked by the user. By clicking a link, a user can be taken to the site of a remote server from which information about the UHF RFID tag or Geotag can then be accessed by the user. However, in the event that the digital screen where tag data code and relative position is presented is not smart, the user can then use an Optical Character Recognition application on a second digital screen that is smart (touch screen) to decipher the tag URL, QR bar code or whatever is provided and link up with the tag information on a remote server where the user can purchase the product/service which the tag contained.

FIG. 5 depicts a computer system adapted and configured to implement the systems and methods described herein. The execution of the sequences of instructions required to practice the embodiments can be performed by a computer system 500 as shown in FIG. 5. In an embodiment, execution of the sequences of instructions is performed by a single computer system 500. According to other embodiments, two or more computer systems 500 coupled by a communication link 515 can perform the sequence of instructions in coordination with one another. Although a description of only one computer system 500 will be presented below, however, it should be understood that any number of computer systems 500 can be employed to practice the embodiments.

A computer system 500 according to an embodiment will now be described with reference to FIG. 5, which is a block diagram of the functional components of a computer system 500. As used herein, the term computer system 500 is broadly used to describe any computing device that can store and independently run one or more programs.

Each computer system 500 can include a communication interface 514 coupled to the bus 506. The communication interface 514 provides two-way communication between computer systems 500. The communication interface 514 of a respective computer system 500 transmits and receives electrical, electromagnetic or optical signals, that include data streams representing various types of signal information, e.g., instructions, messages and data. A communication link 515 links one computer system 500 with another computer system 500. For example, the communication link 515 can be a LAN, in which case the communication interface 514 can be a LAN card, or the communication link 515 can be a PSTN, in which case the communication interface 514 can be an integrated services digital network (ISDN) card or a modem, or the communication link 515 can be the Internet, in which case the communication interface 514 can be a dial-up, cable or wireless modem.

A computer system 500 can transmit and receive messages, data, and instructions, including program, i.e., application, code, through its respective communication link 515 and communication interface 514. Received program code can be executed by the respective processor(s) 507 as it is received, and/or stored in the storage device 510, or other associated non-volatile media, for later execution.

In an embodiment, the computer system 500 operates in conjunction with a data storage system 531, e.g., a data storage system 531 that contains a database 532 that is readily accessible by the computer system 500. The computer system 500 communicates with the data storage system 531 through a data interface 533. A data interface 533, which is coupled to the bus 506, transmits and receives electrical, electromagnetic or optical signals, that include data streams representing various types of signal information, e.g., instructions, messages and data. In embodiments, the functions of the data interface 533 can be performed by the communication interface 514.

Computer system 500 includes a bus 506 or other communication mechanism for communicating instructions, messages and data, collectively, information, and one or more processors 507 coupled with the bus 506 for processing information. Computer system 500 also includes a main memory 508, such as a random access memory (RAM) or other dynamic storage device, coupled to the bus 506 for storing dynamic data and instructions to be executed by the processor(s) 507. The main memory 508 also can be used for storing temporary data, i.e., variables, or other intermediate information during execution of instructions by the processor(s) 507.

The computer system 500 can further include a read only memory (ROM) 509 or other static storage device coupled to the bus 506 for storing static data and instructions for the processor(s) 507. A storage device 510, such as a magnetic disk or optical disk, can also be provided and coupled to the bus 506 for storing data and instructions for the processor(s) 507.

A computer system 500 can be coupled via the bus 506 to a display device 511, such as, but not limited to, a cathode ray tube (CRT) or a liquid-crystal display (LCD) monitor, for displaying information to a user. An input device 512, e.g., alphanumeric and other keys, is coupled to the bus 506 for communicating information and command selections to the processor(s) 507.

According to one embodiment, an individual computer system 500 performs specific operations by their respective processor(s) 507 executing one or more sequences of one or more instructions contained in the main memory 508. Such instructions can be read into the main memory 508 from another computer-usable medium, such as the ROM 509 or the storage device 510. Execution of the sequences of instructions contained in the main memory 508 causes the processor(s) 507 to perform the processes described herein. In alternative embodiments, hard-wired circuitry can be used in place of or in combination with software instructions. Thus, embodiments are not limited to any specific combination of hardware circuitry and/or software.

The term “computer-usable medium,” as used herein, refers to any medium that provides information or is usable by the processor(s) 507. Such a medium can take many forms, including, but not limited to, non-volatile, volatile and transmission media. Non-volatile media, i.e., media that can retain information in the absence of power, includes the ROM 509, CD ROM, magnetic tape, and magnetic discs. Volatile media, i.e., media that can not retain information in the absence of power, includes the main memory 508. Transmission media includes coaxial cables, copper wire and fiber optics, including the wires that comprise the bus 506. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes can be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention can be implemented in a variety of computer systems. The various techniques described herein can be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language can be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system can also be considered to be implemented as a computer-readable storage medium, configured with a computer program, where the storage medium so configured causes a computer to operate in a specific and predefined manner. Further, the storage elements of the exemplary computing applications can be relational or sequential (flat file) type computing databases that are capable of storing data in various combinations and configurations.

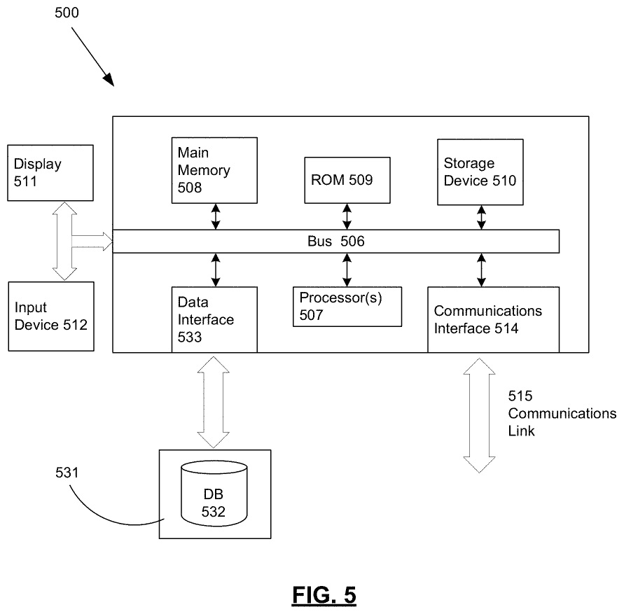

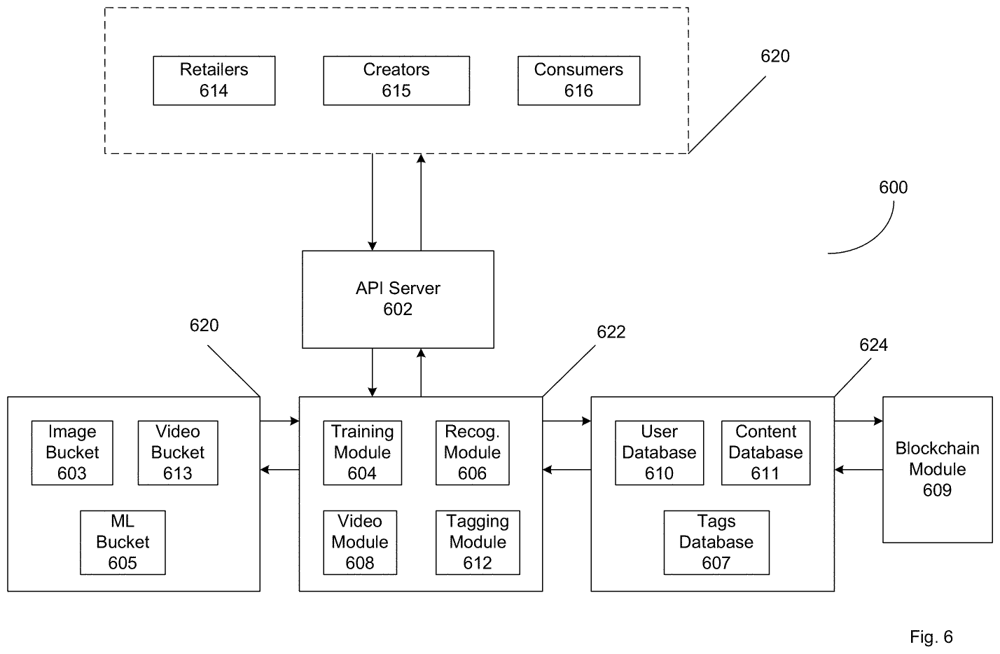

FIG. 6 depicts a system and method of parallel data capture 600 of one or more items with item tagging and identification. In the embodiment depicted in FIG. 6, the system and method 600 can comprise an Application Programming Interface (API) server 602 in communication with a access module 618, a video storage module 620, an identification (ID) module 622, a database (DB) module 624 and a blockchain module 609.

In the embodiment depicted in FIG. 6, the access module 618 can comprise, sub-modules for retailers 614, creators 615 and consumer 616 adapted and configured to enable delivery of video content to the API server 602 and/or other modules 620, 622, 624, 609 for further processing, identification, tagging, storage and/or transactions.

In the embodiment depicted in FIG. 6, the retailers module 614 enables receipt of data regarding products which can be comprised of images of products, label names, prices, product description(s), physical dimensions, geometry, physical characteristic and configuration information, quantity(ies), varieties, location of physical product or data related as to where such product(s) is/are available for purchase online or physically.

In the embodiment depicted in FIG. 6, the creators module 615 enables receipt of data regarding products which can be comprised of images of products, label names, prices, product description(s), physical dimensions, geometry, physical characteristic and configuration information, quantity(ies), varieties, location of physical product or data related as to where such product(s) is/are available for purchase online or physically. Additionally, the creators module allows users to communicate directly or indirectly with product suppliers such that product suppliers can provide creative content providers with products to be featured or to appear in the content provider's creative content. The communication system can allow and/or facilitate transfer of information about relevant products to be conveniently provided to the creators module 615 from the product supplier and/or from the retailers module 614. That is, in some embodiments, a supplier or retailer can communicate with a content creator via the creators module 615 and upon agreement (paid or otherwise) between the supplier or retailer and the content creator that a certain product will be featured as part of the content creator's content, the creator module 615 enables input of data (which can be comprised of images of products, label names, prices, product description(s), physical dimensions, geometry, physical characteristic and configuration information, quantity(ies), varieties, location of physical product or data related as to where such product(s) is/are available for purchase online or physically) related to the product which will appear in the content creator's content.

In the embodiment depicted in FIG. 6, the consumers module 616 allows consumer to access video content and enables consumer to obtain data regarding products shown in the content which can comprise additional images of products, label names, prices, product description(s), physical dimensions, geometry, physical characteristic and configuration information, quantity(ies), varieties, location of physical product or data related as to where such product(s) is/are available for purchase online or physically.

In the embodiment depicted in FIG. 6, the API server 602 can serve as an interface between the access module 618 and the video storage 620, ID 622, DB 624 and Blockchain 609 modules.

In the embodiment depicted in FIG. 6. the API server 602 is in electrical communication with the ID module 622 and the ID module is comprised of a training module 604, a recognition module 606, a video module 608 and a tagging module 612. In the embodiment depicted in FIG. 6, the training module enables data regarding a product, such as geometry, shape, ratios, spacing, identifying features, logos/branding and/or any other known, convenient and/or desired identifying property or characteristic to be associated with a product, such that future instances of such product can be identified based upon the identified properties and/or characteristics. In some instances, this property and characteristic data can be provided via the retailers module 614, the creators module 615 and/or be received in any other known, convenient and/or desired matter.

In some embodiments, the system 600 can asynchronously receive a reference to a 2 dimensional image and geometry from the designated database as provided by the retailer (geometry data was generated by localization action described in the following paragraphs and stored in the designated database) and such information can be passed to the training module 604. If 3-dimensional image information is received, a conversion can be performed at the point of upload by a 3-dimensional image conversion module. In some embodiments, a data directory to a variable, such as, DATADIR (by way of non-limiting example) and labels of images/products can be set to CATEGORIES variable (naming conventions for the variable directories are exemplary only and can vary from the examples used here). By way of non-limiting example:

DATADIR =‘. . . /input/images/ProductClassification’

CATEGORIES=[‘Adi 700 Yucky Boost’, ‘Pugo Future Super’, ‘Nikita Airforce 1’, ‘Alenware m15 R4’, ‘inaPhone13’]

Before training, the dataset images can be converted into a array form, as 2-dimensional data is better suited for use. By way of non-limiting example:

$$X = [ ] Y = [ ]$$

for categories, label in training_data:

X.append(categories)

Y.append(label)

X=np.array(X).reshape(lenofimage, −1)

##X=tf.keras.utils.normalize(X, axis=1)

In some embodiments, the coordinates of the geometry of the image can be supplied by the retailer by the action of localization, along with the product label, product description and price and/or any other known, convenient and/or desired data. The label/name can be appended tot the record, after which a unique brand ID and product ID can be autogenerated for that product. The image can then be sent to its designated storage module 620, while the geometry, description, price and product label are sent to the database module 624.

The data obtained from the retailer can be used to train the model to perform image recognition on the frames of a video. For this to occur, the images for the product uploaded to the video storage module 620, the product label and the geometry obtained by localization along with the support vector machine algorithms are used to initiate the machine learning training process. By way of non-limiting example, to train the model these parameters can be initialized as follows:

```
  SVMModel =
  ClassificationSVM ResponseName: ′Y′
  CategoricalPredictors: [ ]
  ClassNames: {″Adi 700 Yucky Boost′,′Pugo Future
  Super′,′Nikita Airforce
1′,′Alenware m15
  R4′,′inaPhone13′}ScoreTransform: ′none′
  NumObservations: 100
  Alpha: [24x1 double]
  Bias: −14.4149
  KernelParameters: [1x1 struct]
  BoxConstraints: [100x1 double]
  ConvergenceInfo: [1x1 struct]
  IsSupportVector: [100x1 logical]
  Solver: ‘SMO′
```

That is, in some embodiments, the physical data associated with features that uniquely identify a product can be stored in connection with the product information.

In the embodiment depicted in FIG. 6, the image bucket 603 can store image information about a given product and/or given frame of video for use by the machine learning 605 and/or recognition 606 modules. Additionally in some embodiments, frames from the image bucket 603 can be stored in the content database 611 and/or in a user database 610 which can contain information about a specific user's interests, search history and/or predicted interests.

In the embodiment depicted in FIG. 6, the video bucket 613 can store video information about a given product and/or given segment of video for use by the machine learning 605 and/or recognition 606 modules. Additionally in some embodiments, video segments from the video bucket 613 can be stored in the content database 611 and/or in a user database 610 which can contain information about a specific user's interests, search history and/or predicted interests.

In some embodiments, a machine learning (ML) bucket 605. In such embodiments, the ML bucket can comprise an adaptable algorithmic analysis model, adapted and configured to selectively parse images and recognize products either known to the system contained with the content 611 and/or tags 607 databases. In this module, new video and/or previously unprocessed content can be parsed to determine if known products are contained within the video/content thus enabling association of tags with the content. In some embodiments, edge detection techniques can be employed to identify object boundaries and geometric properties and such boundaries and geometric properties can be compared with known geometric properties of products previously associated with tags in the content 611 and tags 607 databases. In some alternate embodiments, other image detection techniques can be employed, such as distance transformation or Euclidean distance, wherein an image is identified by defining a binary digital image, consisting of feature and non-feature pixels and pixels are segmented into an image where all non-feature pixels have a value corresponding to the distance to the nearest feature pixel. Moreover, in still further alternate embodiments, edge and/or contour detection can be employed to identify products, whereby curve fitting techniques are employed to join all the continuous points having the same color, hue, saturation or intensity to identify edges of images and rank them hierarchically.

In the embodiment depicted in FIG. 6, the blockchain module 609 can enable commerce to be achieved either on a Blockchain or via a centralized system using alphanumeric codes. In either case, every product or service is digitized on the platform with a unique alphanumeric code that allows for each product/service to be tracked across the platform or e-commerce process, thereby bringing accountability to the transaction system.

In some embodiments, products or services sold using the system 600, on the Blockchain, products and services can be minted on a metadata provided.

By way of non-limiting example, the j son script shown below can be implemented.

FOR PRODUCTS

```
{
  “type” : !product category”
  “name” : !product name”
  “description” : !product description”
  “Image” : !link to image from our central database”
  “contentURI” : !product link on our website”
  “Id” : !alphanumeric or RFID code”
  “brand” : !product brand”
}
```

Product category can then be represented by an integer between 1-62. However, in some embodiments an alternate numbering sequence can be employed.

Each integer can stand for a product category.

Product ID can be represented by an alphanumeric code generated by the web or mobile app via a cloud function or an RFID code and the product ID can have certain rules to check the validity of the code.

FOR SERVICES

```
{
  “type” : !service category”
  “name” : !service name”
  “description” : !service description”
  “Image” : !link to image from our central database”
  “contentURI” : !service link on our website”
  “Id” : !alphanumeric or RFID code”
  “brand” : !service brand”
  “starttimestamp” : !start of NFT validity period”
  “endtimestamp” : !end of NFT validity period”
}
```

Service category can also be represented by integers.

Service ID can also be represented by an alphanumeric code generated by the web or mobile app via a cloud function or an RFID code.

RFID code can be checked to determine if it conforms to the RFID service code standard.

Start time stamp can enable the timer to be set for the burn function for a service

Non-fungible Tokens (NFTs) can be employed to limit validity, such as for tickets to a show.

Additionally, an end time stamp can aid in determining the time at which the said service NFT will be expire, thus creating a temporal use window for the service.

As is known, actions carried out on a Blockchain are not controlled by a single entity but transactions can be verified by the input of several parties at certain milestones of the process such as the seller receiving the economic value for a product after a customers validates satisfaction with a particular product or service.

In some embodiments, NFTs can be employed to provide authenticity within the Ecommerce space. In some embodiments, the NFTs can employ UHF RFID codes to provide their own uniqueness. The UHF RFID tags with embedded codes can be representative of physical products or services on the ground.

In some embodiments, after a consumer finds a product/service of interest in a video, the consumer can completed an e-commerce transaction to make a purchase using a Blockchain purchase implementation or via a card/mobile payment. In the case of a Blockchain purchase, the use of an NFT is optional. In such transactions, a UHF RFID code can be used to digitize the unique product or service and also to tokenize the NFT. By way of non-limiting example, on the Ethereum Blockchain and ERC 1155 smart contract, the UHF RFID code (which represents a unique physical retail commodity) can form part of the unique id for the non-fungible ERC 721 aspect of the token. Ultimately, such a token which will represent the digital commodity (which itself, represents a physical commodity) is traded on the Blockchain. Third-party courier logistics services the consumer and independent Ethereum validators, all playing verifying and validating roles on the Blockchain ecosystem. This way, the product can be tracked throughout its supply chain with primarily the UHF RFID code.

In some alternate embodiments, the blockchain module 609 can include other DLT options, such as Directed Acyclic Graph (DAG) and/or any other known, convenient and/or desired commercial transaction system and/or method.

In the embodiment depicted in FIG. 6, the tagging module 604 can identify the location of product having tagged data in the tags database 607. The tagging module 607 can generate and/or identify an appropriate GUI for each product or service on the video frame associated with a tag in the tags database 607. In some embodiments, the tagging module 604 can employ circular shapes which can be morphed into other shapes for example a rounded rectangle to display or accommodate further information about the product or service. However, in alternate embodiments the location of a tagged product or service within a frame can be tagged using any know, convenient and/or desired shape or geometry that is identifiable by a user.

In a first mode of operation, a retailer 614 or supplier can provide a content creator 615 with data related to a product they would like included in the content creator's content. Information regarding the product is then provided to the training module 604 via the API 602 and the training module 604 in cooperation with the Machine Learning module 605 can determine image features which can be used to identify the product within video. Such information can then be stored in a content database and information regarding the product can be stored in the tags database 607. In some embodiments, video and/or identified frames can also be stored in the image bucket 603 and/or video bucket 613. Upon receipt of video from a creators module 615, the video can be parsed to determine if the video already contains tags related to known products. Additionally, the video can be parsed against the content database 611 to determine if any frames contain known products. Product tags from the product tags database 607 can then be associated with frames of the video. The video with associated tags can then be returned to the video module 608 wherein the video with associated tags can be presented via the consumers module 616 via the API server 602.

When a user selects a tagged product within the video, information related to the tag can be retrieved from the tags database 607 and information regarding the content can be retrieved from the content database 611 and presented to the user. In some embodiments a user can then use the provided information regarding the product and the associated tag to commence a commercial transaction which can be performed using the blockchain module 609 thereby enabling a consumer to complete a secure transaction to purchase the product.

In an alternate mode of operation, a retailer 614 or supplier can provide a content creator 615 with data related to a product they would like included in the content creator's content. Information regarding the product is then provided to the training module 604 via the API 602 and the training module 604 in cooperation with the Machine Learning module 605 can determine image features which can be used to identify the product within video. Such information can then be stored in a content database and information regarding the product can be stored in the tags database 607. In some embodiments, video and/or identified frames can also be stored in the image bucket 603 and/or video bucket 613. Upon receipt of video from a consumer module 615, the video can be parsed to determine if the video already contains tags related to known products. Additionally, the video can be parsed against the content database 611 to determine if any frames contain known products. Product tags from the product tags database 607 can then be associated with frames of the video. The video with associated tags can then be returned to the video module 608 wherein the video with associated tags can be presented via the consumers module 616 via the API server 602.

When a user selects a tagged product within the video, information related to the tag can be retrieved from the tags database 607 and information regarding the content can be retrieved from the content database 611 and presented to the user. In some embodiments a user can then use the provided information regarding the product and the associated tag to commence a commercial transaction which can be performed using the blockchain module 609 thereby enabling a consumer to complete a secure transaction to purchase the product.

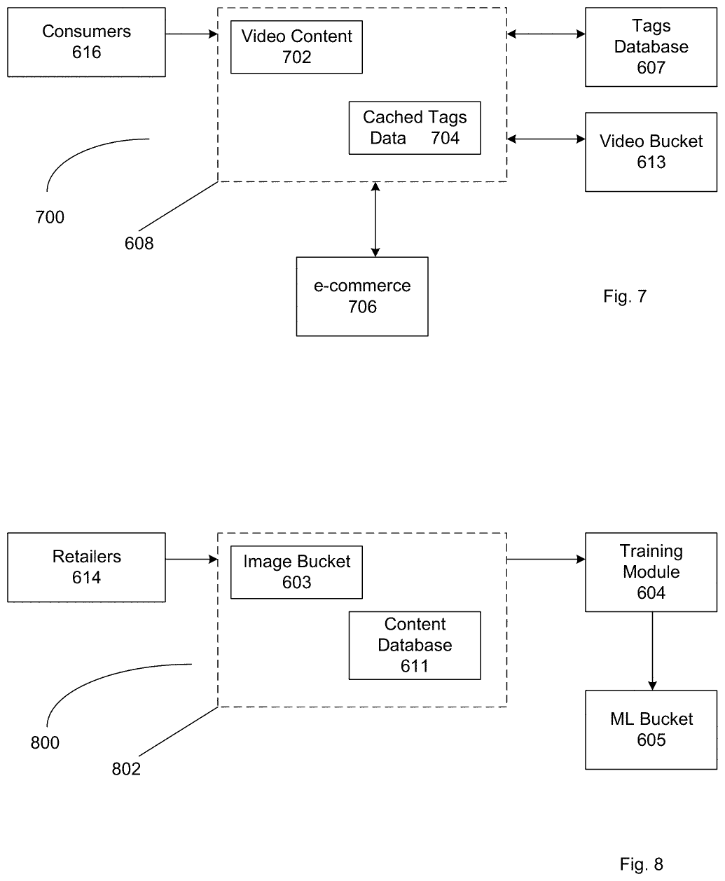

FIG. 7 depicts a system and method 700 employed in association with the system and method of FIG. 6, which can be associated with a consumer interaction. In the embodiment depicted in FIG. 7, the consumers module 616 can deliver video content 702 via the video module 608 wherein the video content 702 has been associated with tag data 704 retrieved from the tags database 607 and, in some embodiments, has been assembled in the video bucket 613. A user can then interact with the tags data 704 within the video content 702 to obtain more information regarding the product and/or engage in an e-commerce transaction 706 via the blockchain module 609 and/or any other known, convenient and/or desired e-commerce system and/or method.

FIG. 8 depicts a system and method 800 employed in association with the system and method of FIG. 6, which can be associated with a retailer interaction. In the embodiment depicted in FIG. 8, the retailers module 614 can interact with both the image bucket 603 and the content database 611 (collectively grouped as the retailer entry point 802), and provide both images and data related to products that can appear within video content. The images and data related to the retailer's product(s) can then pass through the training module 604 wherein identifying features are established and then the ML bucket can be updated with the identifying feature information such that the product(s) can be tagged in video content.

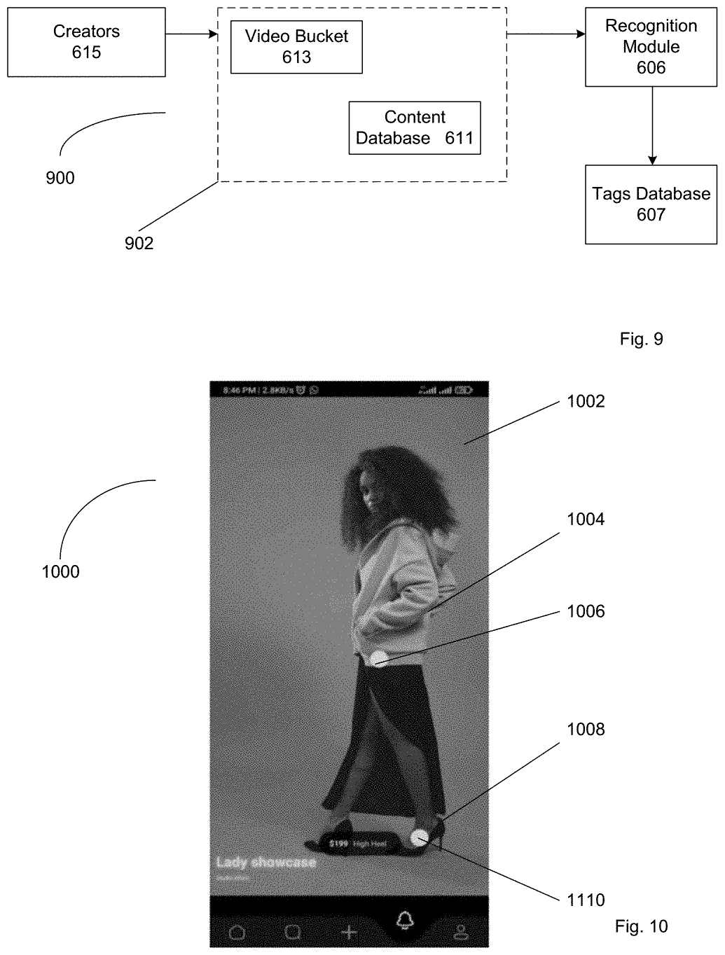

FIG. 9 depicts a system and method employed in association with the system and method of FIG. 6, which can be associated with a content creator interaction. In the embodiment depicted in FIG. 9, the creators module 615 can deliver video content to the video bucket 613 and the content database 611 (collectively grouped as creator entry point 902). The delivered video content can then be processed by the recognition module 606 to identify products and associated tags within the video content and then identified tags can be passed to the tags database 607.

FIG. 10 and exemplary embodiment of a tagged image 1000 employing the systems and methods of FIGS. 6-9. In operation, a user can access a video 1002 and indicate interest in one or more objects within the video—by way of non-limiting example, a jacket 1004 and/or a pair of shoes 1008. Tag can be present in the video, 1006 1008, associated with each of the items of interest. A user can then interact with the tags 1006 1008 and obtain information regarding the products of interest and/or initiate a commercial purchase transaction through the blockchain module 609 to purchase the item.

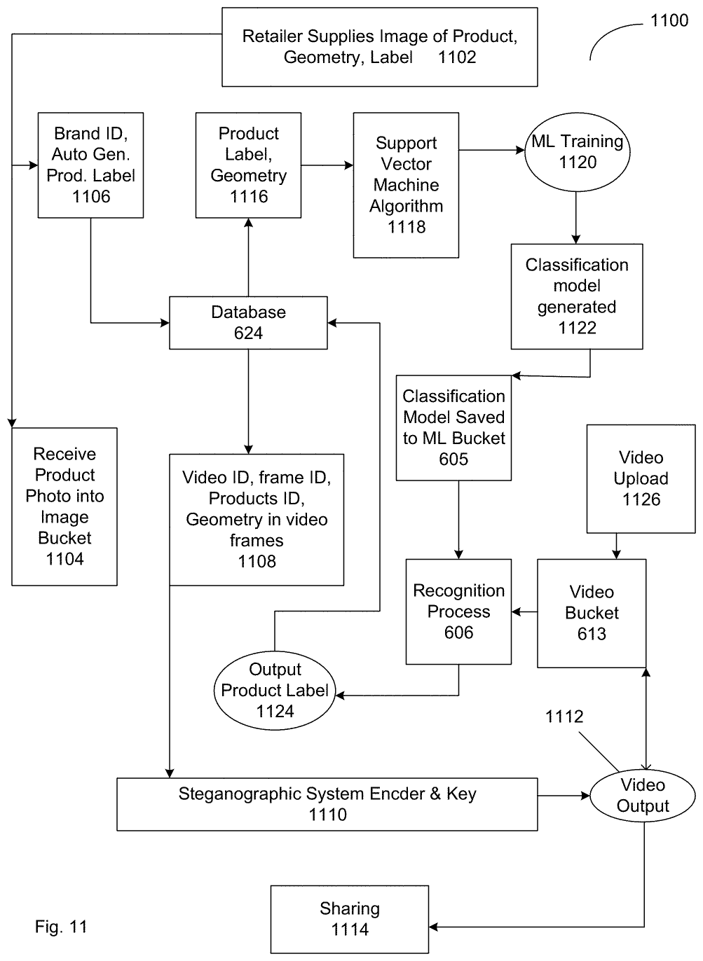

FIG. 11 depicts a system and method employed in association with the system and method of FIG. 6, which can be associated with a retailer interaction. In step 1102, a retailer can supply a product image and information, such as geometric properties, identifying labels, pricing information, product details and/or any other cognizable information that can be used to identify or describe the product. Then in step 1104 image can then be delivered the image bucket 603 and delivered to the ID module 622 wherein the training module 604 can be provided with information collected regarding the product and a tag can be generated for the product 612. The image and the information can then be delivered to the database 624 for storage and be used for identification of the product within future video content.

In step 1108 a video ID, frame ID, product ID/ UHF RFID Code and tags can be combined and delivered to a steganographic encoding system and the video content can be encoded and delivered to a video out module 1112 and the content can be shared with the user in step 1114.

In step 1116, product labels and product geometry can be identified and passed to and processed by the support vector machine algorithm in step 1118 to identify products within the video content.

In step 1120 machine learning training can be implanted, as described in association with the ML bucket 605, wherein products within the video content are identified. Images can then be classified and grouped in step 1122 to generate a product classification algorithm to facilitate and reduce searching times. The ML bucket 605 can then be updated with new product classification method information, to facilitate and reduce search times when analyzing video content for products from the database module 624.

In step 606, the recognition process can be run on the video content to identify products within the video and then in step 1124 product tags/labels can be generate and associated with the video and the resulting content delivered to the database 624 wherein further processing and recognition can be performed and the video can be encoded and delivered for viewing/sharing in step 1114.

In an alternate method of accessing the same process, in step 1126 video can be uploaded to a video bucket 613 and the content in the video bucket can be delivered to step 606 and the recognition process can be applied to the video, tags/labels identified in step 1124 and then delivered to the database 624 wherein further processing and recognition can be performed and the video can be encoded and delivered for viewing/sharing in step 1114.

In some embodiments, a consumer tag request can be initiated by pausing or interacting with an icon or button in the GUI and/or some other gesture like screen grabbing (taking screenshots) and querying. In the case of consumer querying by screenshots (or video clip), the embedded steganographically embedded screenshot (or steganographically encoded video) can cause the AI in the video module to decode the steganographic material by obtaining the equivalent frame number from the screenshot(in the case of a screenshot) or the product id number and geometry or whatever data about the product is encrypted in the screenshot or the frames of the video.

After the steganographic decoding action, the tagging module 607 can then be initiated by the video module to perform tagging of the products on the selected raster images. The tagged image or video (if the original input query was a video, the tagged images or frames can be converted back to a tagged video). In some embodiments, such can be accomplished by placing a GUI tag on the corresponding position of all products and services on the frame as supplied by video module 106 from the downloaded and cached data.

When the respective tags have been placed on products and services, the tagged image of video can automatically be sent back to consumer, who can then able to interact with the retail commodities to find out more information about the product or service and/or engage in a commercial transaction to purchase the product or service. either on the Blockchain 609 or user database 610 and/or any other known, convenient and/or desired e-commerce system.

Steganography is the art of hiding information in an effort to conceal the existence of the embedded information. It serves as a better way of securing message than cryptography which only conceals the content of the message not the existence of the message. Steganography can also be referred to as stego, and it involves the practice of concealing messages or information within other non-secret text—inside a “carrier” message.

Video steganography comprises two procedures which are the embedder and detector. The embedder has two data sources, which are payload implying the amount of secret message inserted inside a cover, and the cover video is utilized as a cover that contains the message inside it.

One aspect of this system and method 600 is that it enabled the users to share video content with other external platforms and download content to their respective devices. Therefore, creators 616 can leverage the platform of the system and method 600 to create and edit video content that can be sent to other platforms or the internet in general. The system and method 600 enables consumers to view video content generated from the platform on the internet or other platform and gives them the ability to find out what products and services are currently on the frame of the video content they are viewing. This can be achieved by sending the video frames through a low-pass filter or anti-alias filter on the consumers device to produce a lossless image or screenshot of the said content or by sharing the actual stego video file with a remote server or platform for analysis to be carried out on it. There the query video can pass through the low-pass filter first before the resulting video signal is sampled with a sampling system to generate discrete lossless images with frequencies up to the Nyquist limit and without aliasing. These good quality raster images can then be steganographically embedded with tags from the tags database 607 with the respective product and service data before they are stringed together again with the help of a lowpass reconstruction on the video/screenshot content can be obtained in form of visible GUI tags and Ecommerce ultimately done.

Many steganographic methods exist, but one modification utilizes the code at a binary level and manipulates the least significant bits (LSB) of individual pixels of the lossless raster image obtained from a video frame after sampling. Thus, pixels in a color image can be represented by 3 bytes, one each for RGB (Red, Green, Blue). The least significant bits for each pixel in a raster image, do not make much of an impact on the visual appearance. Therefore, the bits of least significance can be replaced by bits representing UHF RFID codes of retail commodities or tags from the tags database 607, without much visible changes to the steganographically encoded image. This allows the encoding of information in binary form into the least significant bits of the pixels of the image. Information such as video ID, frame ID, product IDs and geometry can thus be concealed in the least significant bits of the pixels of the image with the aid of a hidden key for encryption and decryption. The image, in turn, can be converted back into frames and video and with a reconstruction filter, such video can thus contain relevant information like video IDs, product IDs and geometry been input in all the video frames. Video encoded using the Least Significant Bit (LSB) method and a Steganographic encryption algorithm can thus carry the product ID and geometry from the database within the video content itself.

In some embodiments, the LSB algorithm can also obtain and read the video obtained from the video bucket, the video can then be segmented into a sequence of frames. A computation of histogram off each frame can be performed before the appropriate frames to encrypt the video ID, frame ID, product IDs and geometry is determined. Moreover, in some embodiments, an encryption key can added and decryption parameters are set. video ID, frame ID, product IDs and geometry can be embedded into frames.

When the video content is uploaded by a consumer either as a video file or screenshot from an external source, in the case of a video it can be segmented into frames then the steganographic decryption algorithm can retrieve the video ID, frame ID, product IDs and geometry from each frame of the video and uses the geometry data obtained from each frame to display tag positions while a query to the database can be generated using the product IDs to obtain further information such as product label, description and price.

In the case of a screenshot the video ID can be used to generate a query to the video bucket and the database 624 to obtain the original video content which can be displayed to the user at the current frame at which the screenshot was taken, and the relevant product information obtained from the database query are placed in the relevant tags by the tagging module.

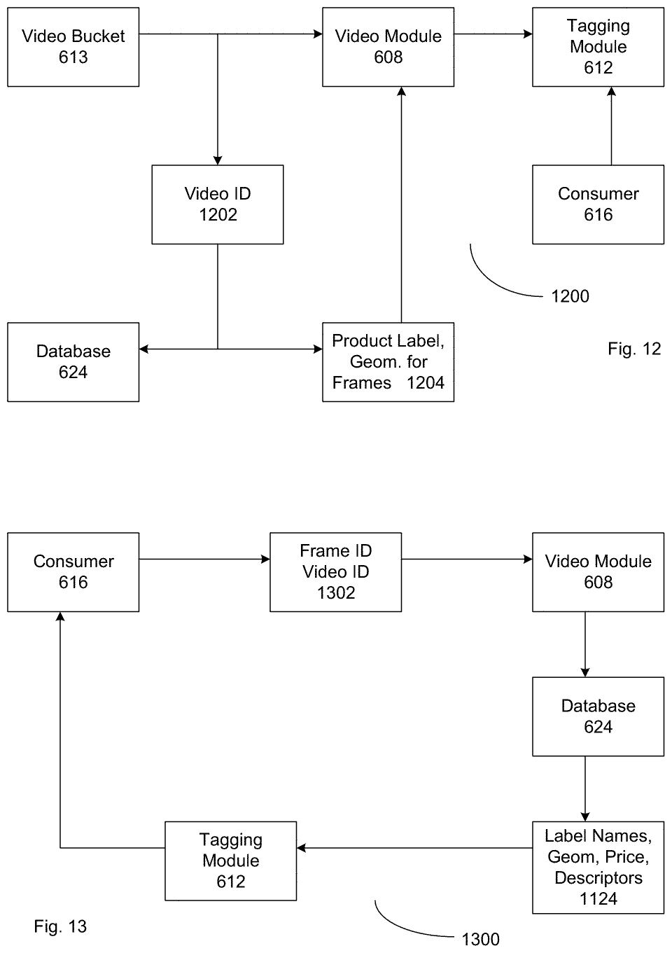

FIG. 12 depicts a system and method 1200 employed in association with the system and method of FIG. 6 related to processing of video/images. The embodiment depicted in FIG. 12, the video bucket 613 can deliver video to both a video ID module 1202 which can associate a unique video ID with the delivered video and deliver the video and the video ID to the database module 624 for storage. Additionally in step 1204, product labels and geometric identifies for frames can be associated with the video information can be delivered to the video module 608 where it can be combined with the original video. The video can then be delivered to the tagging module 612 where appropriate tags are associated with the video content and the content is then delivered to the consumer 616 for viewing.

FIG. 13 depicts a system and method 1300 employed in association with the system and method of FIG. 6, which can be associated with a consumer interaction. In the embodiment depicted in FIG. 13, a consumer module 616 can transmit video to the system 600 and video IDs and Frame IDs can be associated with the video. The video content can then be passed to the video module 608 and relevant information stored in the database module 624. In step 1124 tags such as label names, geometries, pricing, descriptions and other information regarding a production can be obtained from the database and then tagged within the video content in step 612. Then the tagged video content can be delivered to the consumer 616.

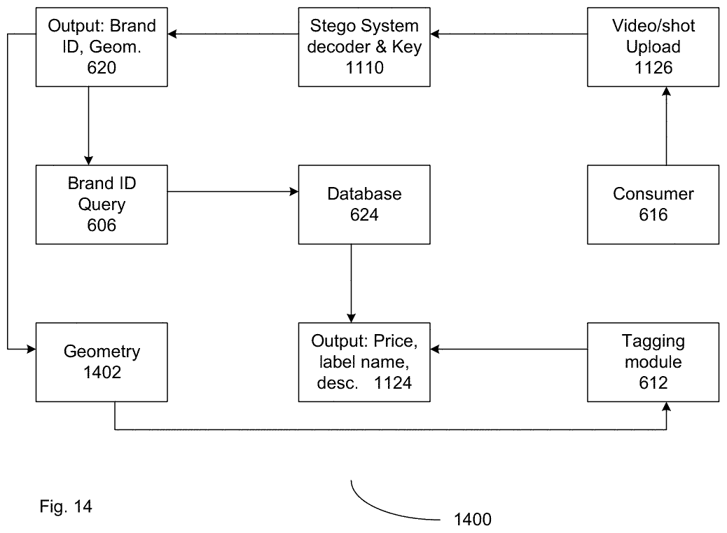

FIG. 14 depicts a system and method 1400 employed in association with the system and method of FIG. 6, which can be associated with a consumer interaction. In the embodiment depicted in FIG. 14, via the consumer module 616, video/still images can be uploaded 1126 to the system 600. The uploaded content can then be steganographically encoded with identifying information in step 1110 and the encoded content can then be analyzed in step 620 to identify shapes or identifiable products/services contained within the content in step 620. Known products can then be analyzed against the database module 624 in step 606 and information related to the identified products can be output to the user with associated tags/labels in step 1124. Alternately, geometries (or other properties identified in the uploaded content) can be analyzed to determine if they are associated with tags and/or can be newly tagged via the tagging module 612. The tags and the video content can then be output to the user with associated tags/labels in step 1124.

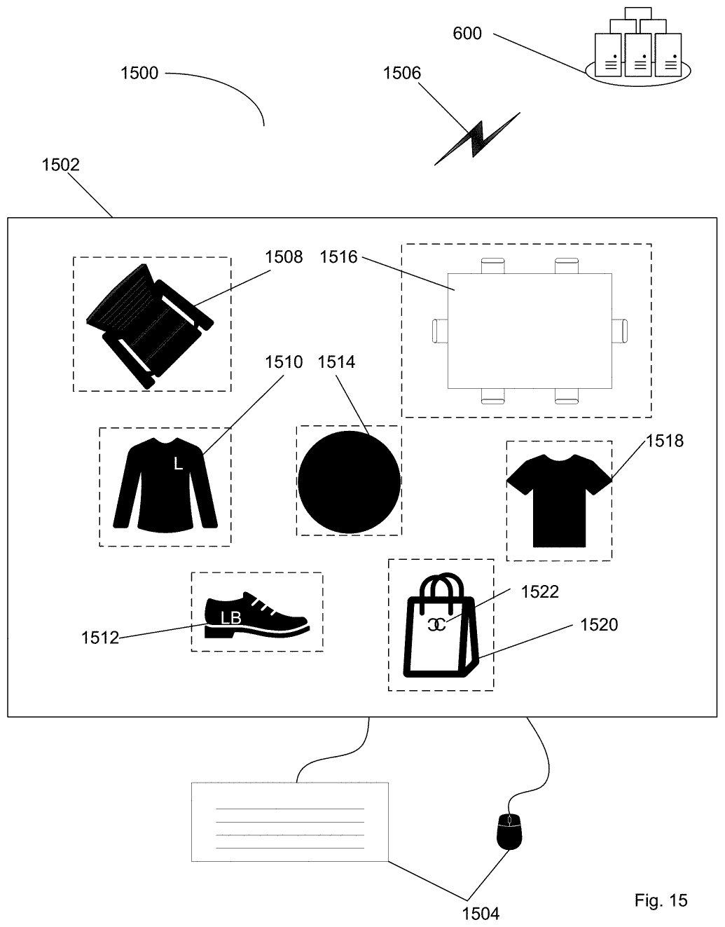

FIG. 15 an exemplary embodiment 1500 of the tagging and item identification/verification systems and methods of FIGS. 6-9 and 11-14. FIG. 15 comprises a display 1502, input devices 1504 and an apparatus for electrical communication with the system and method 600. Within the display 1502 multiple items 1508 1510 1512 1514 1516 1518 1520 can be displayed or viewed in video content. In some embodiments, one of more of the items can contain one or more identifiable logos 1522. In operation, a user can select an item shown in a video on the display 1502 to obtain more information regarding the product. The system 600 can then access the system 600 and the system 600 can provide additional information regarding the identified product and/or purchasing information, in accordance with the detailed description provided above. A user then can institute a purchase transaction to purchase the item and/or merely obtain additional information regarding the product, such as product pricing and availability and/or additional information regarding the product.

Although exemplary embodiments of the invention have been described in detail and in language specific to structural features and/or methodological acts above, it is to be understood that those skilled in the art will readily appreciate that many additional modifications are possible in the exemplary embodiments without materially departing from the novel teachings and advantages of the invention. Moreover, it is to be understood that the subject matter defined in the appended claims is not necessarily limited to the specific features or acts described above. Accordingly, these and all such modifications are intended to be included within the scope of this invention construed in breadth and scope in accordance with the appended claims.

What is claimed:

1. A system comprising:
a retailer module having memory adapted and configured to accept product images, product information, and product identifying information related to one or more products;
a tagging module having memory and storage adapted and configured to generate unique identifying tags associated with each of said one or more products;
a database module having storage for storing product images, product information, product identifying information and tags; and
an identification module having memory adapted and configured to receive video content and identify said one or more products contained with said video content;
wherein said unique identifying tags are associated with video content associated with said one or more products contained within said video content to generate concatenated video content; and
wherein said concatenated video content is delivered to a consumer.

2. The system of claim 1 comprising:
a consumer module adapted and configured to enable consumer viewing and interaction with said concatenated video content.

3. The system of claim 2 wherein consumer interaction with said concatenated video content results in delivery of information regarding said one or more products contained within said video content.

4. The system of claim 3 comprising:
a commercial transaction module adapted and configured to enable a commercial transaction between a consumer and a retailer related, at least in part, to said one or more products contained within said video.

5. The system of claim 2 comprising:
a commercial transaction module adapted and configured to enable a commercial transaction between a consumer and a retailer related, at least in part, to said one or more products contained within said video.

6. The system of claim 2 comprising:
a creator module adapted and configured to enable upload of video content to said identification module wherein said one or more products is identified within said video content.

7. The system of claim 6 comprising:
a consumer module adapted and configured to enable consumer viewing and interaction with said concatenated video.

8. The system of claim 7 comprising:
a commercial transaction module adapted and configured to enable a commercial transaction between a consumer and a retailer related, at least in part, to said one or more products contained within said video.

9. The system of claim 6 comprising:
a commercial transaction module adapted and configured to enable a commercial transaction between a consumer and a retailer related, at least in part, to said one or more products contained within said video.

10. The system of claim 9 wherein said one or more products contained within said video content are identified, at least in part, by one or more properties of said one or more products.

11. The system of claim 10 wherein one of said one or more physical properties is geometric properties of said one or more products.

12. The system of claim 10 wherein one of said one or more physical properties is the presence of a logo on said one or more products.

13. The system of claim 1 wherein said one or more products contained within said video content are identified, at least in part, by one or more properties of said one or more products.

14. The system of claim 13 wherein one of said one or more physical properties is geometric properties of said one or more products.

15. The system of claim 13 wherein one of said one or more physical properties is the presence of a logo on said one or more products.

16. The system of claim 14 comprising:
a consumer module adapted and configured to enable consumer viewing and interaction with said concatenated video.

17. The system of claim 16 comprising:
a commercial transaction module adapted and configured to enable a commercial transaction between a consumer and a retailer related, at least in part, to said one or more products contained within said video.

18. The system of claim 1 comprising:
a consumer module adapted and configured to enable consumer viewing and interaction with said concatenated video.

19. The system of claim 18 comprising:
a commercial transaction module adapted and configured to enable a commercial transaction between a consumer and a retailer related, at least in part, to said one or more products contained within said video.

20. The system of claim 19 wherein one of said one or more physical properties is the presence of a logo on said one or more products.
